(19) United States
(12) Patent Application Publication
(10) Pub. No.: US 2006/0053633 A1
(43) Pub. Date: Mar. 16, 2006

(54) Cutterhead for motorised scissors

(76) Inventor: Josep Gurri Molins, Sant Feliu Codines (ES)

Correspondence Address: RATNERPRESTIA, P O BOX 980, VALLEY FORGE, PA, 19482-0980, US

(21) Appl. No.: 11/209,297

(22) Filed: Aug. 23, 2005

(30) Foreign Application Priority Data
Sep. 15, 2004 (ES) U 200402117

(51) Int. Cl. B26B 15/00

(52) U.S. Cl. 30/228

(57) ABSTRACT

A motorised scissors cutterhead comprises a support adapted to couple to a motor or power supply. An active jaw is mounted adjacent a fixed jaw and attached to a pivoting element arranged to rotate with respect to the shaft and connected to the driving shaft of the motor or power supply. The shaft has head at one end and a screw thread at the opposite end. At least one radial bearing is located between a central area of shaft and pivoting element and at least one axial bearing is arranged around shaft. A first axial bearing is located next to a first end of the radial bearing, further away from the support, and in contact with pivoting element. A second axial bearing is located next to an opposite end of the radial bearing and in contact with pivoting element or with the active jaw attached thereto.

### FIELD OF THE INVENTION

This invention relates to a cutterhead for motorised scissors having a fixed jaw and an active jaw driven by a motor or power supply, wherein the active jaw is provided to rotate with respect to a shaft around which a radial bearing and two axial bearings are included to guide its movements.

### BACKGROUND

Cutterheads for motorised scissors are well known in the state of the art, which include a support with an arm to which a fixed jaw is attached. A shaft is located through aligned holes in said arm and said fixed jaw. A pivoting element including an active jaw is mounted so as to rotate with respect to said axis with the active jaw adjacent to the fixed one. The shaft has a head at one end and a screw thread at the opposite end, to which there is attached a nut that is tightened to pack the ensemble of the support, the fixed jaw, the active jaw, and the pivoting element between the said head and said nut. Generally, the support is joined to a motor or power supply and a mechanical transmission is arranged to transmit the movement from an outlet shaft of the motor or power supply to the pivoting element.

Document ES-A-1050292, in the name of the current applicant, describes a head for motorised scissors, of the type described above, wherein the head of the shaft is on the side corresponding to the pivoting element and the shaft is attached to the nut by its screw threaded end in the side corresponding to the support. Between the head of the shaft and the pivoting element a radial ball bearing is provided and between the active jaw and the fixed jaw an axial needle bearing is provided. In its day, this arrangement represented an advance over prior art heads. Also, in the head of said document ES-A-1050292, the support has a coupling portion adapted to couple to a motor or power supply and a cavity wherein there is housed a bevel pinion attached to a driving shaft of said motor or power supply, while in the pivoting element a toothed crown sector is formed that is arranged to mesh with said bevel pinion.

An objective of this invention is to provide a head for cutting scissors that provides greater cutting stability, and a reduced size and weight. The needle bearings have advantages over the ball bearings, which makes them favourable for achieving this objective.

This invention contributes to significantly improving the prior art heads by providing a cutterhead for motorised scissors of the type comprising, as is known, an adapted support for coupling to a motor or power supply and with an arm to which a fixed jaw is attached; a shaft mounted through aligned holes on said arm and said fixed jaw; an active jaw mounted adjacent to said fixed jaw and attached to a pivoting element arranged so as to rotate with respect to said shaft and connected to a driving shaft of said motor or power supply by means of a mechanical transmission. Said shaft includes a head at one end and a screw thread at the opposite end, to which there is attached a nut for packing the ensemble between said head and said nut. Around the shaft at least one radial bearing and at least one axial bearing is provided. The head of this invention is characterised in that it includes a radial bearing between a central area of the shaft and the pivoting element; a first axial bearing located next to a first end of said radial bearing, further away from the support, and in contact with the pivoting element; and a second axial bearing located next to a second, opposite, end of the radial bearing and in contact with the pivoting element or with said active jaw attached thereto.

In one embodiment, the shaft is blocked by the end thereof that corresponds to the head with respect to the support, and said first axial bearing is arranged in contact on one side with the pivoting element and on the other side with the said nut attached to the opposite end of the shaft. The radial bearing is inserted in a passage of the pivoting element between an inner surface of said passage and an outer surface of the shaft. The second axial bearing is arranged in contact, on one side, with an outer surface of a projection of the pivoting element that passes through a hole in said active jaw and, on the other side, with the fixed jaw attached to the support.

In other words, the head of this invention comprises a stationary ensemble made up of the support, the fixed jaw, the shaft and the nut, attached to one another, and a mobile ensemble made up of the pivoting element and the active jaw attached thereto. The mobile ensemble includes a passage through which the shaft is inserted, so that the mobile ensemble has three interfaces with the stationary ensemble, two of which are axial and one radial. According to this invention, in the three interfaces respective bearings are arranged, which provides greater robustness in the assembly of the shaft and a greater guiding of the mobile ensemble, both with respect to the shaft, since the radial bearing is arranged in a central area thereof, and with respect to the nut and the support or fixed jaw, since it has bearings on both sides.

In this specification, the term “bearing” is used to designate both low friction elements as ball/roller bearings, and the terms “axial bearing” and “radial bearing” to designate low friction elements or ball/roller bearings adapted to mainly withstand compression stresses in the axial direction and in the radial direction with respect to the shaft, respectively. In the head of this invention, the said radial bearing is preferably a radial needle bearing and said first and second axial bearings are radial needle bearings. This enables a significantly compact design while also providing tread contacts with very low rotation resistance. Consequently, a considerable tightening torque can be applied to the nut without blocking the rotation of the mobile ensemble. However, acceptable results can be achieved by means of a similar construction but including low friction bushings, e.g., ceramic as opposed to needle bearings.

### DRAWINGS

The above characteristics and advantages and others will be more fully understood from the following detailed description of an embodiment with reference to the attached drawings, in which:

FIG. 1 is an upper view of a cutterhead for motorised scissors according to an embodiment of this invention;

FIG. 2 is a cross-section view according to the line II-II in FIG. 1; and

FIG. 3 is an amplified view of the detail indicated with the circle III in FIG. 2.

### DETAILED DESCRIPTION

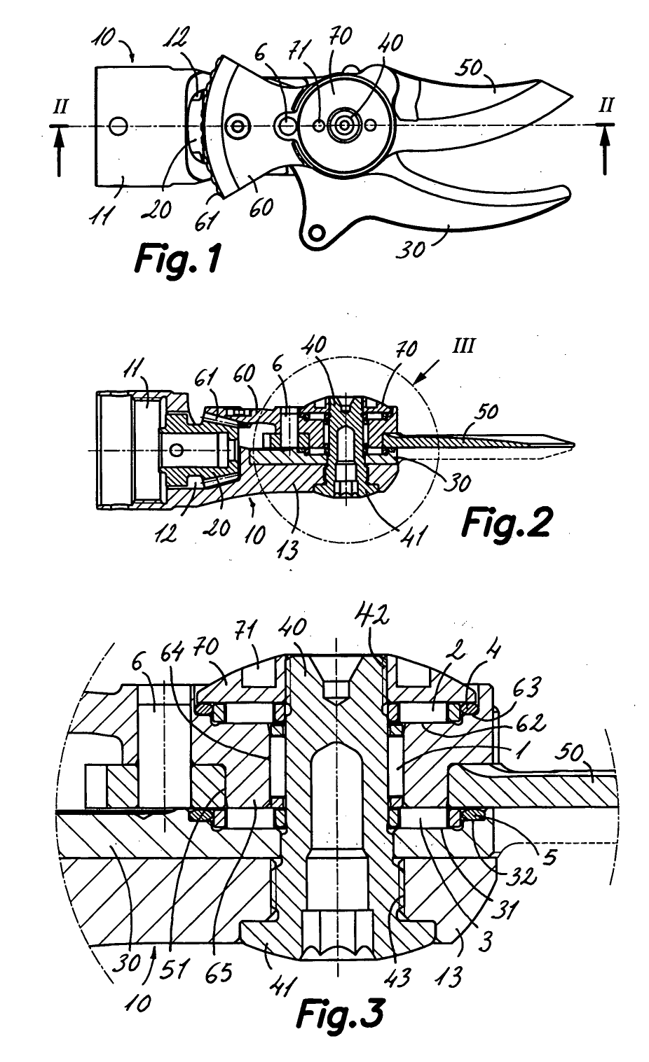

With reference first of all to FIGS. 1 and 2, the cutterhead for motorised scissors according to an embodiment of this invention includes a support 10 having a coupling portion 11 provided, for example, with an inner screw thread adapted for coupling to a conjugated threading on the housing of a motor or power supply (not shown). Next to said coupling portion 11, the support has a cavity 12 wherein there is housed a bevel pinion 20 attached to a driving shaft of said motor or power supply, and following an arm 13 to which there is attached, by conventional means, a fixed jaw 30. Said arm 13 and said fixed jaw 30 have respective mutually aligned holes through which a shaft 40 is mounted. This shaft 40 has a head 41 at one end adjacent to arm 13 of support 10, and an outer screw threaded portion 43 next to said head. Shaft 40 is blocked by the end thereof that corresponds to head 41 with respect to support 10, by virtue of a coupling of said outer screw threaded portion 43 in a conjugated thread formed in the corresponding hold of arm 13.

An active jaw 50 is securely attached, by conventional means such as a pin 6, to a pivoting element 60 defining a passage 64 for shaft 40. This pivoting element 60 has a projection 65 formed around said passage 64, and the said active jaw 50 has a hole 51 in which said projection 65 is inserted, so that an outer surface of projection 65 is substantially level with an outer surface of said active jaw 50. Shaft 40 is inserted in said passage 64 so that active jaw 50 remains mounted adjacent to said fixed jaw 30 and arranged to rotate, attached to pivoting element 60, with respect to said shaft 40.

At one end of pivoting element 60 a toothed crown sector 61 is formed, concentric to shaft 40 and shaped and arranged so as to mesh with said bevel pinion 20. Shaft 40 has an end, opposite head 41, at which there is formed a screw thread 42. This threaded end projects from pivoting element 60 to couple with a nut 70. This way, a stationary ensemble made up of support 10 and fixed jaw 30, attached to one another, and a mobile ensemble made up of pivoting element 60 and active jaw 50, attached thereto, are packed between head 41 of the shaft and nut 70, with active jaw 50 applied against fixed jaw 30.

In said passage 64 of pivoting element 60 there is inserted a radial bearing 1, which is preferably a radial needle bearing, so that it makes contact on one side with an inner surface of passage 64 and on the other side with an outer surface of shaft 40. In a first annular cavity 62 formed in pivoting element 60 there is housed a first axial bearing 2, which is in contact on one side with pivoting element 60 and on the other side with a surface of said nut 70 attached to the opposite end of shaft 40. For this purpose, nut 70 has a radial extended configuration to provide sufficient diameter for said surface, and includes gripping configurations 71 for coupling by means of a tightening tool. In a second annular cavity 31 formed in fixed jaw 30 there is housed a second axial bearing 3, which is arranged in contact on one side with an outer surface of said projection 65 of pivoting element 60 and on the other side with fixed jaw 30 attached to support 10. Preferably, both the first and the second axial bearing are axial needle bearings.

Thus, the cutterhead according to this invention comprises a radial bearing 1 between a central area of shaft 40 and pivoting element 60; a first axial bearing 2 located next to a first end of said radial bearing 1, further away from support 10, and in contact with pivoting element 60; and a second axial bearing 3 located next to a second, opposite, end of radial bearing 1 and in contact with pivoting element 60. Alternatively, the second axial bearing 3 could be in contact, on one side, with active jaw 50 linked to pivoting element 60 and, on the other side, with a surface of support 10 to which fixed jaw 30 is attached.

In order to protect the bearings from dirt and dust, the head has a first sealing ring 4 arranged around the first axial bearing or axial needle bearing 2 and in contact on one side with pivoting element 60 and on the other side with said radially extended surface of nut 70, and a second sealing ring 5 arranged around the second axial bearing or axial needle bearing 3 and in contact on one side with fixed jaw 30 and on the other side with active jaw 50. Advantageously, and in order to obtain as compact a construction as possible, housing 64 of pivoting element 60 communicates via its ends with the first and second annular cavities 62, 31, and the radial bearing or radial needle bearing 1, is retained in the axial direction by the contact of its first and second ends with the first and second axial bearings or axial needle bearings 2, 3, respectively. Said first sealing ring 4 is housed in a first step 63 formed in said first annular cavity 62 so that, on its inner side, it rests in contact with a perimetric surface of the first axial needle bearing 2. Similarly, said second sealing ring 5 is housed in a second step 32 of said second annular cavity 31 and in contact, on its inner side, with a perimetric surface of the second axial needle bearing 3.

This construction provides a significantly compact and lightweight construction. At the same time, the head presents great cutting stability provided by the possibility of applying a considerable high tightening torque to the nut without blocking or jamming the rotation of the mobile ensemble thanks to the two needle bearings arranged on both sides of the mobile ensemble made up of the pivoting element and the active jaw. This greater tightening torque opposes the tendency of the fixed and active jaws to separate owing to the cutting stress, which provides a better shearing effect.

An expert in the field will be capable of introducing several variations and modifications to the described and illustrated embodiment without departing from the scope of this invention as defined in the attached claims.

1. A cutterhead for motorised scissors, comprising;
a support adapted to couple to a motor or power supply and with an arm to which there is attached a fixed jaw;
a shaft mounted by means of holes aligned in said arm and said fixed jaw;
an active jaw mounted adjacent to said fixed jaw and attached to a pivoting element arranged to rotate with respect to said shaft and connected to a driving shaft of said motor or power supply by means of a mechanical transmission, comprising said shaft, a head at one end and a screw thread at the opposite end, to which there is attached a nut for packing the ensemble between said head and said nut, and with at least one radial bearing and at least one axial bearing being arranged around said shaft,
wherein said radial bearing is located between a central area of said shaft and said pivoting element; and
further comprising:
a first axial bearing located next to a first end of said radial bearing, further away from said support, and in contact with said pivoting element; and
a second axial bearing located next to a second, opposite, end of radial bearing and in contact with said pivoting element or with said active jaw attached thereto.

2. The cutterhead, according to claim 1, wherein said shaft is blocked by the end thereof that corresponds to said head with respect to said support, and said first axial bearing is arranged in contact on one side with said pivoting element and on the other side with said nut attached to the opposite end of said shaft.

3. The cutterhead, according to claim 2, wherein said pivoting element defines a passage in which there is inserted said shaft and a projection around said passage inserted in a hole of said active jaw, and said second axial bearing is arranged in contact on one side with an outer surface of said projection of said pivoting element and on the other side with said fixed jaw attached to said support.

4. The cutterhead, according to claim 3, wherein said first axial bearing is housed in a first annular cavity formed in said pivoting element and said second axial bearing is housed in a second annular cavity formed in said fixed jaw.

5. The cutterhead, according to claim 4, wherein said radial bearing is inserted in said passage of said pivoting element and retained in the axial direction by the contact of its first and second ends with the first and second axial bearings, respectively.

6. The cutterhead, according to claim 4, further comprising:
a first sealing ring arranged around said first axial bearing and in contact on one side with said pivoting element and on the other side with said nut, and
a second sealing ring arranged around said second axial bearing and in contact on one side with said fixed jaw and on the other with said active jaw.

7. The cutterhead, according to claim 6, wherein said first sealing ring is housed in a first step formed in said first annular cavity and in contact, on its inner side, with said first axial bearing and said second sealing ring is housed in a second step of said second annular cavity and in contact, on its inner side, with said second axial bearing.

8. The cutterhead, according to claim 1, wherein said radial bearing is a radial needle bearing and said first and second axial bearings are axial needle bearings.

9. The cutterhead, according to claim 1, wherein said support comprises a cavity in which there is housed a bevel pinion attached to a driving shaft of said motor or power supply, and in said pivoting element there is formed a toothed crown section shaped and arranged to mesh with said bevel pinion.
